(19) United States
(12) Patent Application Publication
(10) Pub. No.: US 2020/0307804 A1
(43) Pub. Date: Oct. 1, 2020

(54) SEAT BACK

(71) Applicant: ACRO AIRCRAFT SEATING LIMITED, Crawley (GB)

(72) Inventor: Adam James CHALLENOR, Crawley (GB)

(21) Appl. No.: 16/837,029

(22) Filed: Apr. 1, 2020

(30) Foreign Application Priority Data
Apr. 1, 2019 (GB) 1904551.7

(51) Int. Cl. B64D 11/06

(52) U.S. Cl. CPC B64D 11/0636; B64D 11/0638

(57) ABSTRACT

Described herein is a seat back for an aircraft seat, the seat back comprising a body, wherein the body comprises a support wall for supporting a passenger leaning against the seat back, a first side wall, a second side wall and a cross brace, wherein the cross brace connects the first side wall and the second side wall at a position between a lower end and an upper end of each of the side walls, and wherein the support wall, the first side wall, the second side wall and the cross brace are integrally formed. Also described is a seat comprising the seat back and a row of seats.

### CROSS REFERENCE TO RELATED APPLICATION

This application claims priority to United Kingdom Patent Application No. GB1904551.7, filed Apr. 1, 2019, which is incorporated herein by reference in its entirety.

### TECHNICAL FIELD

The present invention relates to seat backs for aircraft seats.

### BACKGROUND ART

Various types of aircraft seat are known which generally comprise a seat base, a seat back and one or more armrests. In order to satisfy airline requirements, it is beneficial to make aircraft seats lighter and to minimise the space that they occupy on an aircraft.

The desire to make aircraft seats lighter often conflicts with the need to make aircraft seats sufficiently strong to survive not only an impact but also everyday wear and tear. The desire to make aircraft seats lighter also conflicts with the expectation of passengers to be provided with an aircraft seat which is not only comfortable, but which also includes various conveniences, such as tray tables, electronics, and so on.

It is, therefore, an object of the present invention to seek to alleviate the above identified problems.

### SUMMARY OF THE INVENTION

According to one aspect of the present invention, there is provided a seat back for an aircraft seat, the seat back comprising a body, wherein the body comprises a support wall for supporting a passenger leaning against the seat back, a first side wall, a second side wall and a cross brace, wherein the cross brace connects the first side wall and the second side wall at a position between a lower end and an upper end of each of the side walls, and wherein the support wall, the first side wall, the second side wall and the cross brace are integrally formed.

Remarkably, the present invention provides a seat back which is not only strong, due to the provision of a support wall, cross brace and side walls, but which is also light by virtue of the cross brace being integrally formed with the support wall and the side walls such that no joints are required. As will be appreciated, in known seat backs in which various structural components are joined together, the joints formed by the various connections must be strong which, in turn, means that the size of the joining ends of the components must be increased to provide a sufficiently secure connection, be this via welding or via connection with bolts. The increase in size and the requirement for welding and/or bolts, results in a heavy seat back, a problem not shared by the seat back of the present invention. The use of multiple components also results in increased assembly times during manufacture, which is also a problem not shared by the present invention.

In specific embodiments of the invention described below, the integrally formed cross brace not only provides strength to the seat back but also provides other functions, such as forming the base of a literature pocket and supporting a latch for a tray table.

Preferably, the cross brace is a cross beam.

Preferably, the cross brace has a substantially U-shaped cross section.

Preferably, the cross brace is formed by a recess in the support wall of the body.

Preferably, the cross brace comprises a rear wall.

Preferably, the cross brace comprises a rear wall, a top wall and a bottom wall.

Preferably, the rear wall, top wall and bottom wall of the cross brace are formed by a recess in the support wall of the body.

Preferably, the recess comprises a substantially U-shaped cross section.

Preferably, the cross brace comprises a recess formed in a forward-facing surface of the support wall of the body. Preferably, the recess has a substantially U-shaped cross-section.

Preferably, the cross brace comprises a projection formed in a rearward-facing surface of the support wall of the body. Preferably, the projection has a substantially U-shaped cross-section.

Preferably, the cross brace comprises a forward-facing opening in the body.

Preferably, the cross brace comprises a receiver for receiving a table latch.

Preferably, the cross brace comprises an aperture for receiving a table latch or a component thereof.

Preferably, the cross brace comprises a first part of a table latch for connection to a second part of a table latch.

Preferably, the cross brace comprises an internal cavity.

Preferably, the cavity comprises a rear wall.

Preferably, the cavity is defined by the rear wall, the top wall and the bottom wall of the cross brace and the first and second side walls of the body.

Preferably, the cross brace comprises one or more apertures.

Preferably, the one or more apertures are in the rear wall of the cross brace.

Preferably, the apertures are for allowing access to the internal cavity of the cross brace.

Preferably, the seat back comprises one or more USB charging sockets located within said one or more apertures.

Preferably, the body comprises a recess defined by the first and second side walls and the cross brace, preferably, a top surface/wall of the cross brace. Preferably, the recess is above the cross brace.

Preferably, the seat back, preferably the body, comprises a cross member positioned across at least a part of the recess. As such, it will be appreciated that the recess forms a literature pocket.

Preferably, the cross brace comprises a cross member positioned across at least a part of the recess.

Preferably, the cross member is selected from a panel, bar, beam, cord, bungee or net.

Preferably, the cross brace forms the base of a literature pocket.

Preferably, the cross brace comprises a cover.

Preferably, the cover is positioned over the top, rear and bottom walls of the cross brace.

Preferably, the cover comprises top, rear and bottom walls for positioning against the top, rear and bottom walls of the cross brace.

Preferably, the cross brace comprises a lip.

Preferably, the cover comprises a lip. As such it will be appreciated that when the cross brace forms the base of a literature pocket, the lip will restrict literature from sliding out of the literature pocket.

Preferably, the lip is on an upper surface of the cover.

Preferably, the body comprises a deformable material positioned between the cover and the cross brace.

Preferably, the lip comprises a hollow space between the cover and the cross brace, wherein said hollow space comprises a deformable material.

Preferably, the deformable material is a resilient material.

Preferably, the deformable material comprises a foam material; preferably, polyurethane foam.

Preferably, the deformable material is a strip of deformable material; preferably, a foam material; preferably, polyurethane foam.

Preferably, the cover comprises one or more apertures for allowing access to the internal cavity of the cross brace.

Preferably, the cross brace comprises one or more apertures for allowing access to the internal cavity of the cross brace and the cover comprises one or more apertures for allowing access to the internal cavity of the cross brace, wherein said apertures of the cross brace and the cover are aligned when the cover is in position against the cross brace.

Preferably, the cover comprises an aperture for receiving a table latch or a component thereof.

Preferably, the cross brace comprises an aperture for receiving a table latch or a component thereof and the cover comprises an aperture for receiving a table latch or a component thereof, wherein said apertures of the cross brace and the cover are aligned when the cover is in position against the cross brace.

Preferably, the seat back comprises a panel on the/a forward facing surface of the support wall of the body.

Preferably, the panel forms a front wall of the cross brace.

Preferably, the panel is formed in at least two parts, preferably two parts.

Preferably, the panel comprises a first side part and a second side part.

Preferably, the panel comprises one or more apertures, which allow access to the/a cavity of the cross brace.

Preferably, the seat back, preferably the base and/or the panel comprises one or more channels for receiving a cable, for example an electrical cable.

Preferably, the seat back, preferably the base and/or the panel comprises one or more apertures, which allow access to the/a cavity of the cross brace, and one or more channels connected to said one or more apertures for allowing a cable to be held within said one or more channels and to enter the cavity of the cross brace through said one or more apertures.

Preferably, the one or more channels comprise one or more grooves formed in the body and/or the panel.

Preferably, the panel at least partially covers the forward-facing surface of the body.

Preferably, the panel covers only a part of the forward-facing surface of the body.

Preferably, the body comprises a composite material; preferably, a carbon fibre composite material.

Preferably, the panel comprises a composite material; preferably, a carbon fibre composite material.

Preferably, the panel partially covers the forward-facing surface of the body.

Preferably, the panel covers side areas of the base and across upper central areas of the base corresponding to the position of the cross brace and a head rest area.

Preferably, the body and the panel are separately formed.

Preferably, the body and the panel are secured together, for example by an adhesive.

Preferably, the side walls project rearward of the support wall of the body.

Preferably, the depth of the side walls away from the support wall of the body is greatest where the cross brace connects the first and second side walls.

Preferably, the depth of the side walls tapers from a maximum depth where the cross brace connects to the first and second side walls to a reduced depth at the upper and lower ends of the side walls.

Preferably, the depth of the side walls at their lower end is minimal.

Preferably, the seat back comprises a deformable layer positioned on a forward facing surface of the body and/or panel.

Preferably, the deformable layer comprises a deformable material, preferably a foam material.

Preferably, the deformable layer comprises a resilient material.

Preferably, the seat back comprises a cover, for example an upholstered cover.

Preferably, the support wall of the body is a curved wall.

Preferably, the support wall of the body is a curved wall comprising a convex surface.

Preferably, the body comprises an upper part and a lower part, said lower part comprising a surface which is curved forward toward each side of the lower part and curved forward toward the base of the lower part.

Preferably, the seat back comprises one or more connectors for connecting the seat back to a frame of an aircraft seat.

Preferably, the one or more connectors comprise one or more first mating parts for mating with one or more second mating parts on the frame of an aircraft seat.

Preferably, the seat back comprises a latch for holding a tray table against the seat back.

Preferably, the cross brace comprises a latch for holding a tray table against the seat back.

Preferably, the latch passes through an aperture in the cover and is secured to the cross brace.

Preferably, the seat back comprises a tray table.

According to another aspect of the present invention, there is provided a seat back for an aircraft seat, the seat back comprising a body, wherein the body comprises a support wall for supporting a passenger leaning against the seat back, a first side wall, a second side wall and a cross brace, wherein the cross brace connects the first side wall and the second side wall and wherein the seat back comprises a recess above the cross brace, and wherein the support wall, the first side wall, the second side wall and the cross brace are integrally formed.

Preferably, the recess is defined by the cross brace, the first side wall and the second side wall.

Preferably, the recess forms a literature pocket.

According to another aspect of the present invention, there is provided a vehicle seat comprising a seat back as described herein.

Preferably, the seat comprises a seat base, a seat frame and a seat back as described herein.

Preferably, the seat is an aircraft seat.

According to a further aspect of the present invention, there is provided a row of seats comprising a plurality of seats as described herein.

It will be appreciated that reference to “one or more” includes reference to “a plurality”.

Within this specification, “integrally formed” means formed as a single piece. That is, the rear wall, side walls and cross brace are not formed of separate pieces which are then joined together.

With this specification, “substantially U-shaped” includes reference to “U-shaped”.

Within this specification, reference to “composite material” includes reference to a carbon fibre composite material, for example, a carbon-fibre-reinforced polymer.

Within this specification, it will be appreciated that reference to rear, rearward and forward is with reference to the direction of travel of an aircraft seat comprising a seat back as described herein, as shown by the arrow in FIG. 5.

Within this specification, it will be appreciated that reference to top, bottom, upper and lower, is with reference to the orientation of an aircraft seat comprising a seat back as described herein, for example when standing on a flat surface in an upright, non-reclined position.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein and vice versa.

### BRIEF DESCRIPTION OF THE DRAWINGS

Example embodiments of the present invention will now be described with reference to the accompanying FIGS., in which:

FIG. 1A shows a rear perspective view of a body of a seat back of the present invention;

FIG. 1B shows a front perspective view of a body of a seat back of the present invention;

FIG. 1C shows a front perspective view of a panel of a seat back of the present invention in which the two halves are joined together;

FIG. 1D shows a front perspective view of a panel of a seat back of the present invention in which the two halves are shown as separate pieces;

FIG. 2 shows a front perspective view of a seat back of the present invention which includes both the body and the panel;

FIG. 3A shows a rear perspective view of a seat back of the present invention which includes a cover, tray table and literature pocket;

FIG. 3B shows a rear perspective view of the seat back shown in FIG. 3A with the cover, tray table and cross panel of the literature pocket in an exploded view;

FIG. 4 shows a rear view of the cover showing the internal components thereof;

FIG. 5 shows a side view of an aircraft seat comprising a seat back of the present invention; and

FIG. 6 shows a rear view of a row of aircraft seats each comprising a seat back of the present invention.

### DETAILED DESCRIPTION

The present invention relates to a seat back for an aircraft seat.

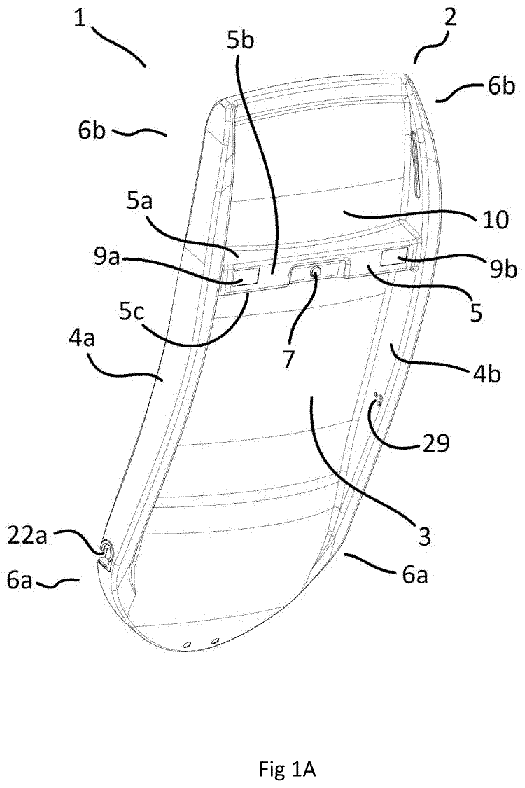

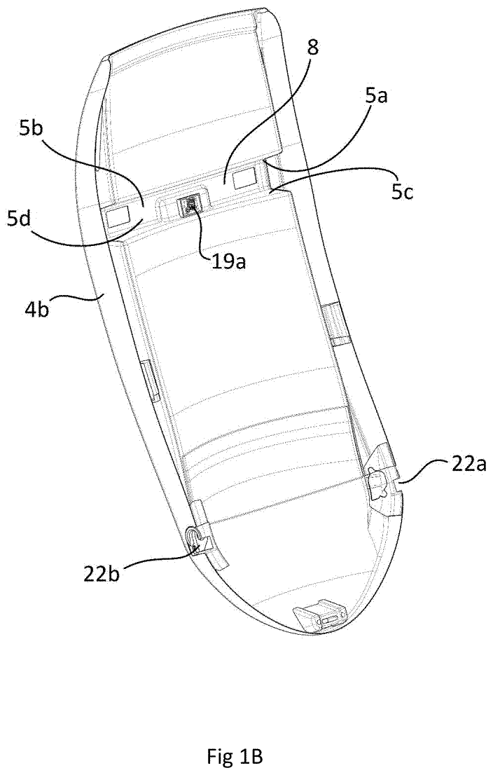

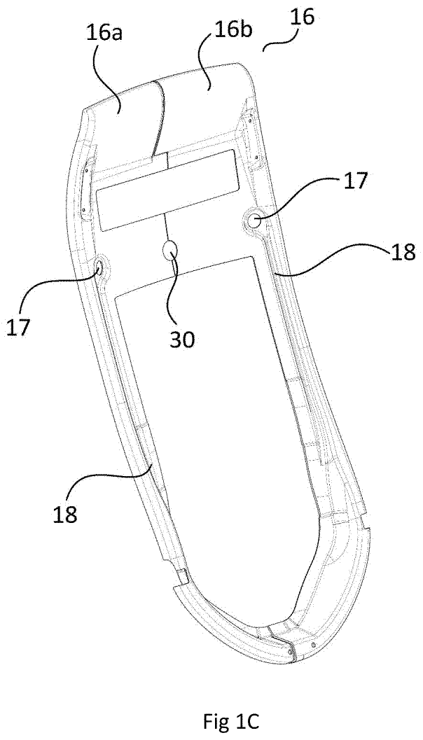

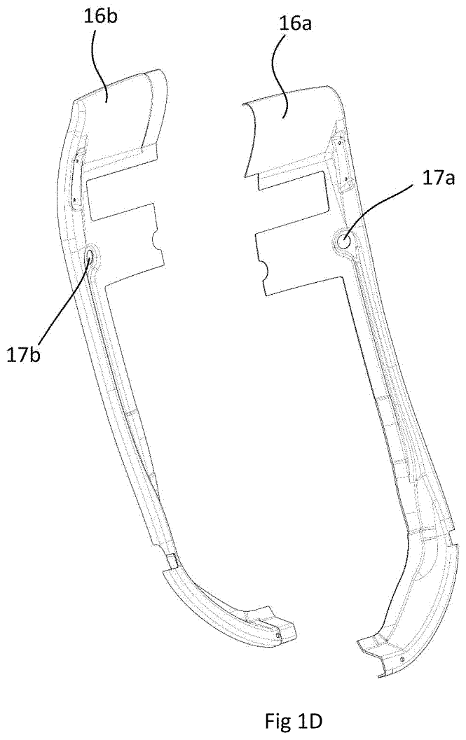

With reference to FIGS., there is shown a seat back 1 for an aircraft seat. With particular reference to FIG. 1A, the seat back comprises a body 2 with a support wall 3 for supporting a passenger leaning against the seat back, a first side wall 4a, a second side wall 4b and a cross brace 5. The cross brace connects the first side wall 4a and the second side wall 4b of the body at a position between a lower end 6a and an upper end 6b of each of the side walls 4a, 4b. The support wall 3, the first side wall 4a, the second side wall 4b and the cross brace 5 are integrally formed. That is, they are formed as a single piece. The cross brace 5 includes a top wall 5a, a rear wall 5b and a bottom wall 5c which form a cavity 8 (as shown in FIG. 1B) with a forward-facing opening 5d. The body is formed from a carbon fibre composite.

As will be evident from the FIGS., the cross brace 5 has a U-shaped cross section and is formed by a deformation in the support wall 3 of the body 2.

The cross brace 5 includes a pair of apertures 9a, 9b which provide access to the cavity 8. In preferred examples, these apertures allow one or more USB charging sockets 27a, 27b to be mounted on the seat back and for the associated cables to pass through the apertures 9a, 9b and the cavity 8.

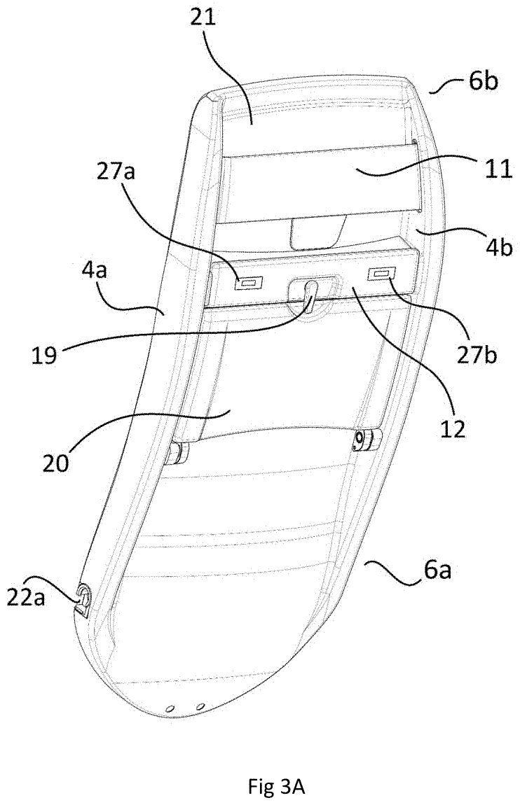

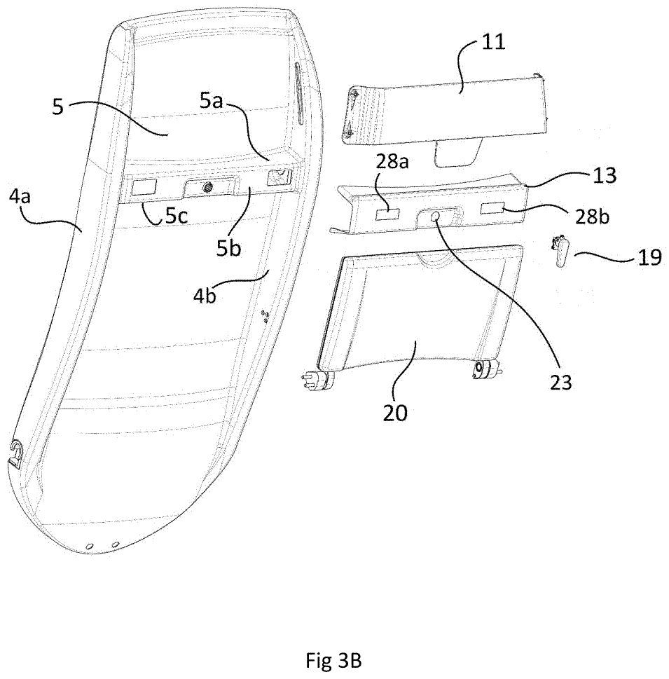

The body 2 includes a recess 10 defined by the first 4a and second 4b side walls and the top wall 5a of the cross brace 5, with the cross brace 5 forming the base of the recess 10. In the example shown, a panel 11 is positioned across the recess to form a literature pocket 21, shown in FIG. 3A.

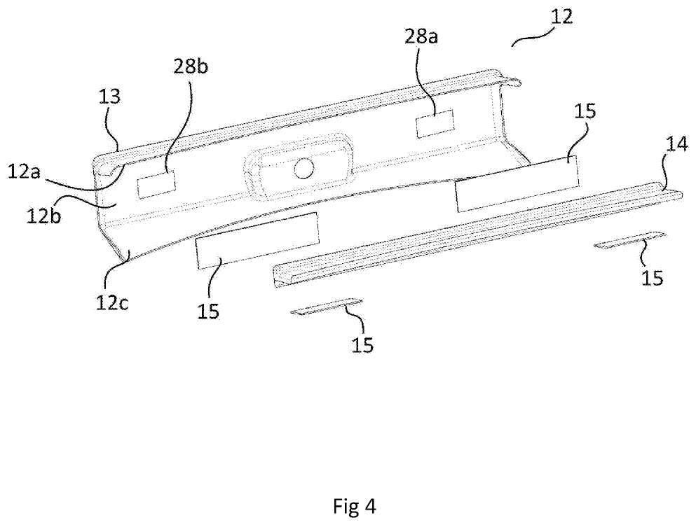

With particular reference to FIGS. 3A and 3B, the cover 12 is positioned around the cross brace 5. As shown in FIG. 4, the cover includes top 12a, rear 12b and bottom faces 12c for positioning against the top 5a, rear 5b and bottom walls 5c of the cross brace.

The cover 12 includes a lip 13 which prevents literature from sliding out of the literature pocket 21. The lip 13 forms a hollow space between the cover 12 and the cross brace 5 which is filled with a strip of polyurethane foam 14 material. This is particularly advantageous because it minimises injury to a passenger in the event of a head impact collision.

In addition to the strip of foam 14, the cover 12 provides additional cushioning around the top 5a, rear 5b and bottom 5c walls of the cross brace 5 because it is manufactured from vacuum formed plastic with moulded polyurethane foam.

The foam 14 is secured to the cover 12 by hook and loop material 15. The cover 12 is secured to the cross brace 5 by hook and loop material 15.

With reference to FIGS. 1C and 1D, in addition to the body 2, in the example shown, the seat back includes a panel 16 on the forward-facing surface of the support wall 3 of the body 2. The panel 16 covers the opening of the cross brace 2 and forms a front wall 5e thereof.

The panel is formed in two parts 16a, 16b which can be joined together. The panel includes a pair of apertures 17a, 17b which allow access to the cavity of the cross brace and which line up with the apertures 9a, 9b in the rear wall of the cross brace 2. The apertures 17a, 17b connect with channels 18 along which cables can be held, for example cables connected to USB charging sockets 27a, 27b held within the apertures 9a, 9b.

The panel also includes an aperture 30 for allowing access to a part 19a of the latch 19.

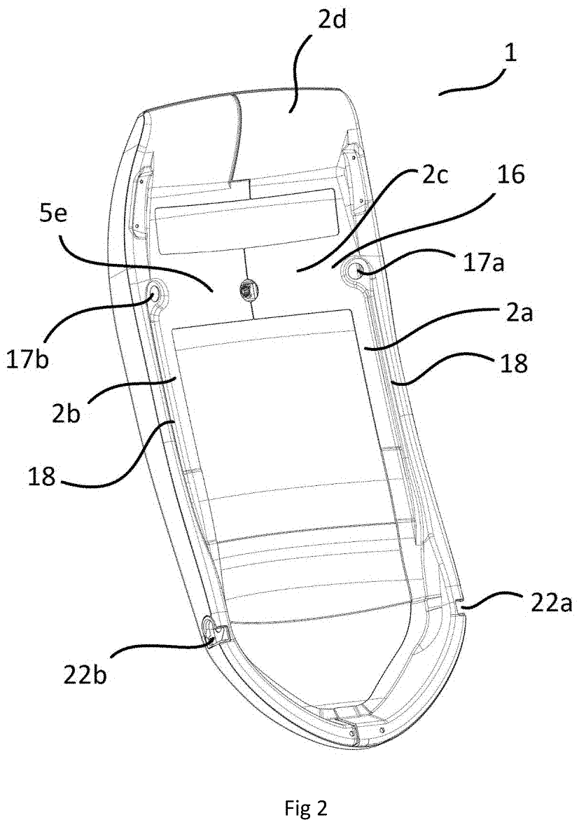

As shown with particular reference to FIG. 2, the panel 16 does not cover all of the forward-facing surface of the body 2, rather it covers side areas 2a, 2b and across upper central areas 2c, 2d corresponding to the position of the cross brace and a head rest area. This maximises the strength afforded by the addition of the panel 16, whilst at the same time minimising the weight of the seat back 1.

As with the body 2, the panel 16 is formed of a carbon fibre composite material. The body 2 and the panel 16 are secured together by an adhesive.

The seat back includes a pair of connectors 22a, 22b in the form of recesses for connecting the seat back 1 to protrusions on the frame 26 of an aircraft seat 24.

A latch 19 is provided for holding a tray table 20 against the seat back 1. The latch 19 passes through an aperture 23 in the cover 12 and is secured to the cross brace 2 via an aperture 7 in the cross brace within or behind which a part 19a of the latch 19 can be provided.

The tray table 20 is secured to the body 2 via holes 29.

The cover 12 also includes a pair of apertures 28a, 28b for allowing access to the internal cavity of the cross brace 5 and within which the USB charging sockets 27a, 27b are provided. The apertures 9a, 9b of the cross brace 5 and the apertures 28a, 28b of the cover 12 are aligned when the cover 12 is in position against the cross brace 5.

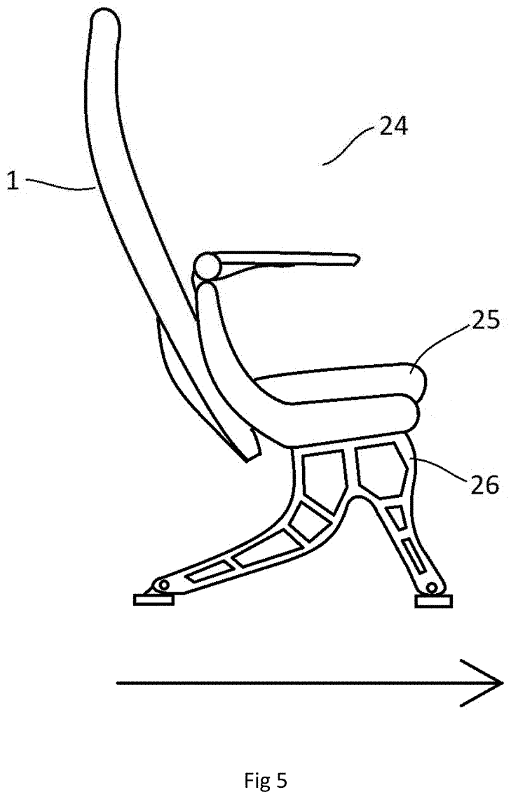

With reference to FIG. 5, there is shown an aircraft seat 24 comprising a seat back as described herein. The seat 24 includes a seat base 25, a seat frame 26 and a seat back 1 as described herein.

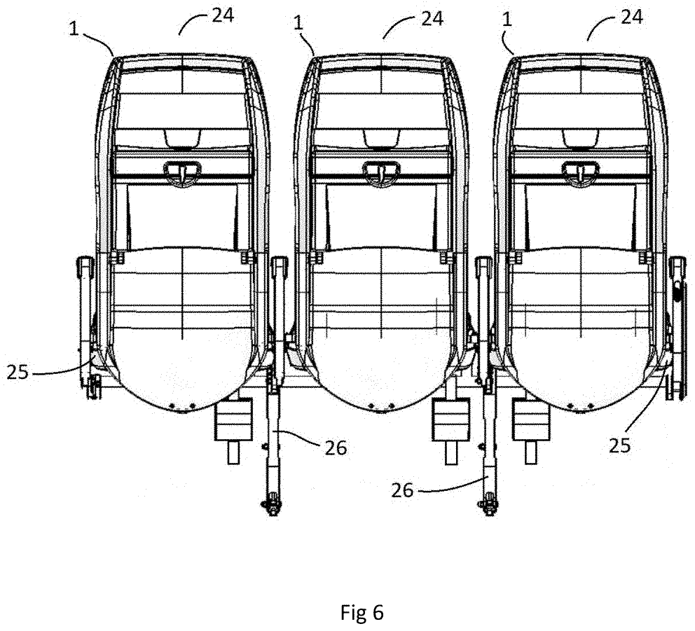

With reference to FIG. 6, there is shown a row of aircraft seats comprising a seat back as described herein.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications are covered by the appended claims.

1. A seat back for an aircraft seat, the seat back comprising a body, wherein the body comprises a support wall for supporting a passenger leaning against the seat back, a first side wall, a second side wall and a cross brace, wherein the cross brace connects the first side wall and the second side wall at a position between a lower end and an upper end of each of the side walls, and wherein the support wall, the first side wall, the second side wall and the cross brace are integrally formed.

2. The seat back according to claim 1, wherein the cross brace is formed by a recess in the support wall of the body.

3. The seat back according to claim 1, wherein the cross brace comprises a forward-facing opening in the body.

4. The seat back according to claim 1, wherein the cross brace comprises a receiver for receiving a table latch.

5. The seat back according to claim 1, wherein the cross brace comprises an internal cavity.

6. The seat back according to claim 5, wherein the cross brace comprises one or more apertures, preferably in a rear wall of the cross brace, for allowing access to the internal cavity.

7. The seat back according to claim 1, wherein the cross brace forms the base of a literature pocket.

8. The seat back according to claim 1, wherein the cross brace comprises a cover.

9. The seat back according to claim 8, wherein the cover comprises one or more apertures for allowing access to the internal cavity of the cross brace.

10. The seat back according to claim 9, wherein the cross brace comprises an aperture for receiving a table latch or a component thereof and the cover comprises an aperture for receiving a table latch or a component thereof, wherein said apertures of the cross brace and the cover are aligned when the cover is in position against the cross brace.

11. The seat back according to claim 8, wherein the cover comprises a lip.

12. The seat back according to claim 11, wherein the lip is on an upper surface of the cover.

13. The seat back according to claim 8, wherein the cross brace comprises a latch for holding a tray table against the seat back and the latch passes through an aperture in the cover and is secured to the cross brace.

14. The seat back according to claim 1, wherein the seat back comprises a panel on a forward-facing surface of the support wall of the body.

15. The seat back according to claim 14, wherein the panel forms a front wall of the cross brace.

16. The seat back according to claim 14, wherein the panel comprises one or more apertures, which allow access to the/a cavity of the cross brace.

17. The seat back according to claim 1, wherein the seat back comprises one or more apertures, which allow access to the/a cavity of the cross brace, and one or more channels connected to said one or more apertures for allowing a cable to be held within said one or more channels and to enter the cavity of the cross brace through said one or more apertures.

18. The vehicle seat comprising a seat back according to claim 1.

19. The row of vehicle seats comprising a plurality of seats according to claim 18.

20. The vehicle seat of claim 18 which is an aircraft seat.
